(19) United States
(12) Patent Application Publication
(10) Pub. No.: US 2006/0101955 A1
(43) Pub. Date: May 18, 2006

(54) Composite wrench kit

(76) Inventor: Hung-Ming Chang, Junghe City (TW)

Correspondence Address: BIRCH STEWART KOLASCH & BIRCH, PO BOX 747, FALLS CHURCH, VA, 22040-0747, US

(21) Appl. No.: 10/989,374

(22) Filed: Nov. 17, 2004

(51) Int. Cl. B25B 23/00; B25B 23/16; B25G 1/08

(52) U.S. Cl. 81/490; 81/438; 81/439; 81/177.1; 81/177.4

(57) ABSTRACT

A composite wrench kit includes a handgrip 10 coupling with a mating sliding cap 15 to hold a hex wrench (a) for turning and fastening. The handgrip further is coupled with a coupling ring 20 which has a wedge flute 21 on the periphery to engage with a first wrench housing 30. The periphery of the first wrench housing 30 may be coupled with a second wrench housing 40 and a hanging hook 50. One or two sets of hex wrenches of British system and metric system and varying sizes may be held in the kit for use. The first and second wrench housing and the hanging hook may also be coupled to become one set for sales. The kit may be configured in various combinations and hung on user's waist belt to facilitate carrying and use.

### FIELD OF THE INVENTION

The present invention relates to a tool kit for hex wrenches and particularly to a composite kit for coupling a plurality of elements and providing dynamic assembly and versatile selections to improve use convenience.

### BACKGROUND OF THE INVENTION

The conventional hex wrench kit, referring to FIG. 1, mostly is organized according to metric system and British system, and arranged sequentially according to the size to hold hex wrenches of different dimensions and specifications. Different bores are provided to mate and hold different sizes and specifications of the hex wrenches. The metric system and British system have different specification scales. For the metric system, some vendors place odd number specifications in one group while the even number specifications on another group and the wrenches in each group are arranged sequentially by size and held in the tool kit. Hence vendors often have to produce tool kits with different insertion bores to mate different sets of hex wrenches. Molding and production costs are higher.

In view of the aforesaid disadvantages, the present invention aims to provide a Lego type wrench kit that can assemble individual elements to become one set and form various combinations to hold wrenches. Tool vendors can save production cost and different combinations and assemblies may be formed for user selection and carrying according to requirements.

### SUMMARY OF THE INVENTION

The primary object of the present invention is to provide a composite wrench kit that allows movable and individual elements to be coupled and assembled as desired so that users can select a first and a second wrench housings of different specifications according to requirements to couple together, or purchase separately, and hang the kit on the waist belt when in use without hindering user's physical movement.

Another object of the invention is to provide a composite wrench kit that has a handgrip containing insertion bores and clipping troughs of varying specifications and a sliding cap on one end of the handgrip to confine a hex wrench to facilitate handgrip turning and tightening.

The composite wrench kit according to the invention includes a rod type handgrip which has at least one bulged wall on the outer periphery and a brake section formed radially on an inner side, a hollow coupling ring to couple on the handgrip that has a trough corresponding to the bulged wall of the handgrip and an indented retaining port on one end of an inner side of the trough and at least one wedge flute on an outer wall, a first wrench housing which has a plurality of insertion bores of different sizes on one end surface and a coupling section on an outer wall to couple with the wedge flute of the coupling ring and a retaining ring on the outer wall, and a second wrench housing which is substantially an annular hook to be coupled on the retaining ring of the first wrench housing and has a plurality of insertion bores of different sizes on an outer end surface of the first wrench housing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional hex wrench tool kit.

FIG. 2 is a perspective view of an embodiment of the present invention.

FIG. 3 is an exploded view of an embodiment of the present invention.

FIG. 4 is a schematic view of the handgrip and coupling ring of the invention.

FIG. 5 is a sectional view of the first wrench housing of the invention.

FIG. 6 is a sectional view of the first and the second wrench housings of the invention in a coupled condition.

FIGS. 7 and 8 are schematic views of the handgrip of the invention coupled with a hex wrench in a use condition.

FIGS. 9 and 10 are schematic views of the first and the second wrench housings coupled with hanging hook in a use condition.

FIG. 11 is a perspective view of the handgrip coupling with the first and the second wrench housings on one side.

FIG. 12 is a schematic view of the second wrench housing hanging on a user's waist belt.

### DETAILED DESCRIPTION OF THE PREFERRED EMBODIMENTS

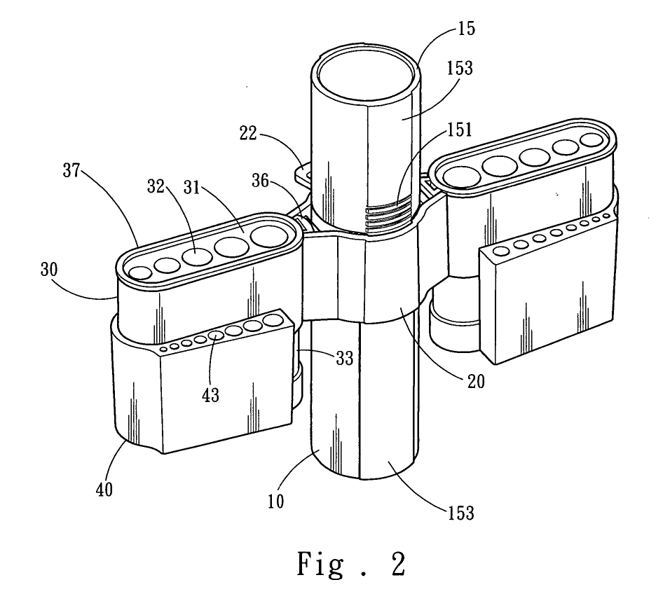

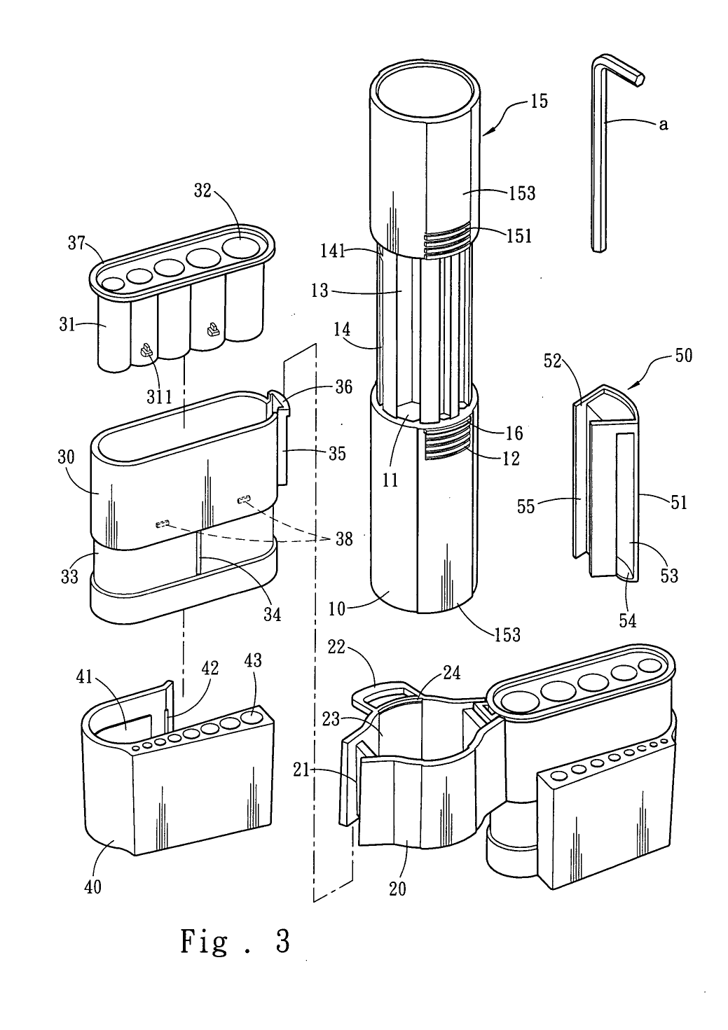

Please referring to FIGS. 2 and 3, the composite wrench kit according to the present invention is made from plastics. It includes:

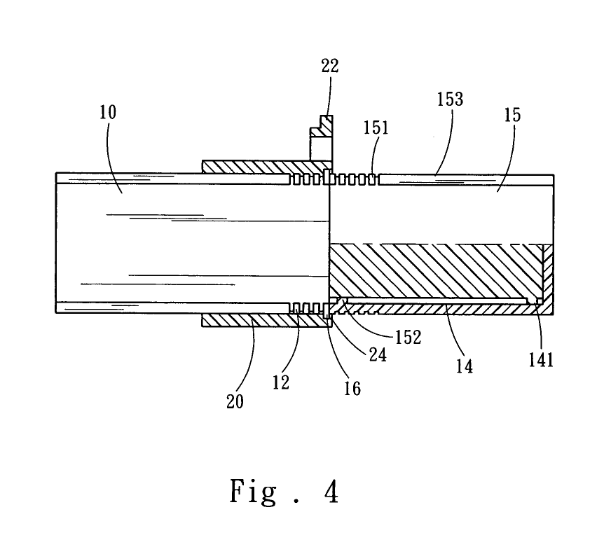

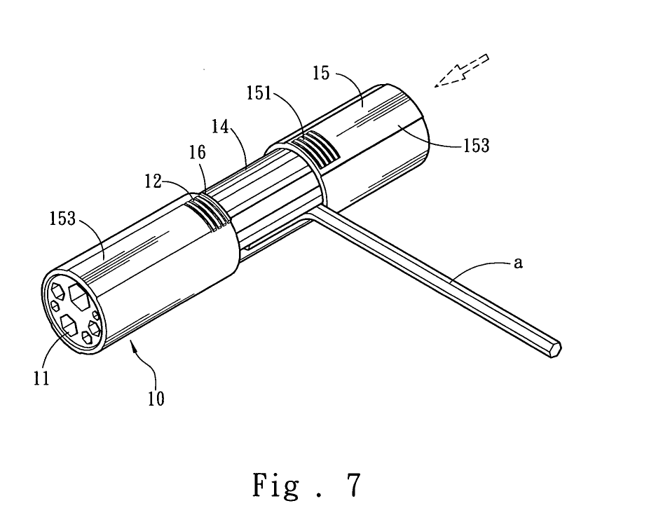

a handgrip 10 which is a round rod having two ends of different diameters. It has a first side of a greater diameter that has a plurality of hex insertion bores 11 of different sizes formed inside. Each of the insertion bores 11 runs through both ends to couple with a hex wrench (a) for turning and tightening. There is a second side with an abutting outer wall marked with an embossed first stripe notation 12. The second side has a smaller diameter and a plurality of polygonal clipping troughs 13 to clamp and hold the hex wrench (a) as shown in FIG. 7. The outer wall has an axial guiding trough 14. The guiding trough 14 has an anchor plate 141 on a rear end. A barrel sliding cap 15 with a diameter same as the outer diameter of the handgrip 10 is provided. The outer wall of the sliding cap has a second stripe notation 151 corresponding to the first stripe notation 12 of the handgrip 10. The sliding cap 15 has a jutting latch hook 152 on one end of an inner wall facing the handgrip 10. Referring to FIG. 4, the handgrip 10 and the sliding cap 15 have respectively a pair of bulged walls 153 corresponding to each other. The handgrip 10 has a jutting brake section 16 abutting one end of the inner wall;

a coupling ring 20 which is hollow and has a wedge flute 21 on each of two opposite outer sides, and a ear 22 on one end of another side to be grasped by hands or hung. It has a trough 23 formed on each of two opposing sides of the inner wall corresponding to and coupling with the bulged walls 153, and an indented retaining port 24 on the inner radial surface corresponding to the brake section 16 as shown in FIG. 4;

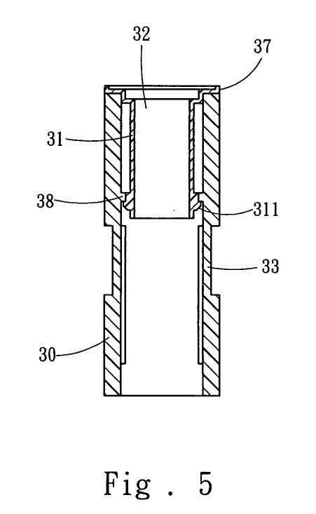

two first wrench housings 30 to couple respectively with the wedge flutes 21 of the coupling ring 20. It is hollow and annular and has one end to receive a holding member 31. The holding member 31 has a plurality of first insertion bores 32 of different sizes, such as two sets of specifications according to the metric system or British system to house the hex wrench (a) of varying specifications. The holding member 31 has two latch spots 311 on two sides to anchor on the inner wall of the first wrench housing 30 when coupled. The first wrench housing 30 has an indented retaining ring 33 on the outer wall and a longitudinal ditch 34 in the center of retaining ring 33 on two opposite sides. The first wrench housing 30 further has a bulged coupling section 35 on one side with a retaining section 36 on one end thereof. The holding member 31 has a flange 37 on one end that is extended outwards to rest on the outer end of the first wrench housing 30. The first wrench housing 30 further has a pair of anchor lugs 38 on a upper side and a lower side of the inner wall to stop the latch spots 311 of the holding member 31 to prevent the holding member 31 from slipping out (referring to FIG. 5);

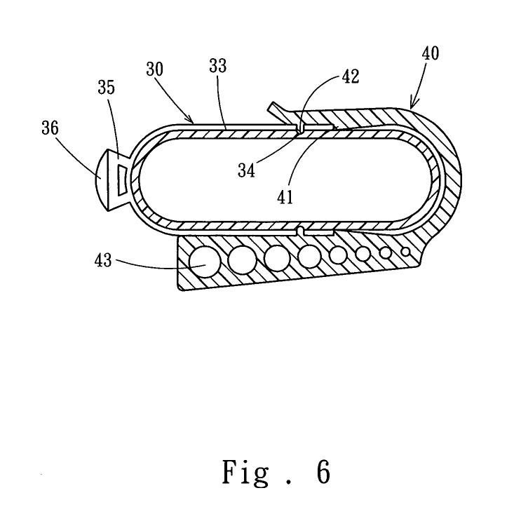

two second wrench housings 40 each is substantially formed in U-shape to couple on the outer side of the first wrench housing 30. It has a desired elasticity to wedge in the retaining ring 33 of the first wrench housing 30. It also has a coupling member 41 on an inner wall corresponding to the retaining ring 33. The coupling member 41 has a latch ridge corresponding to the ditch 34 of the retaining ring 33 as shown in FIG. 6. The second wrench housing 40 has a plurality second insertion bores 43 of varying sizes that are smaller than the first insertion bores 32 of the first wrench housing 30 to hold small hex wrenches a; and

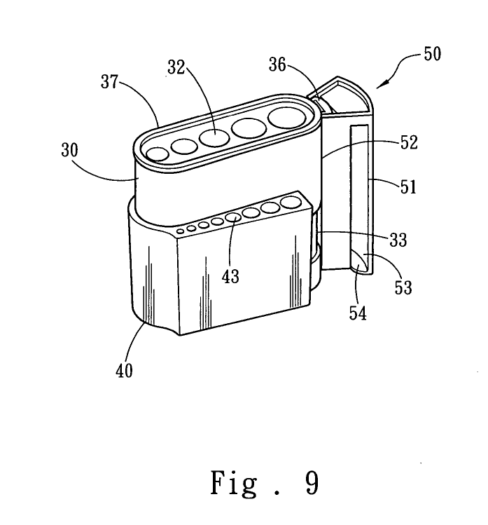

a hanging hook 50 formed in a wedge shape (referring to FIGS. 3 and 9) that has an outer wall 51 greater than an inner wall 52, and a longitudinal slot 53 with an opening directing downwards. The outer wall 51 has a clipping blade 54 extended inwards to taper the opening at the bottom. The inner wall 52 has a coupling trough 55 formed in a wedge shape.

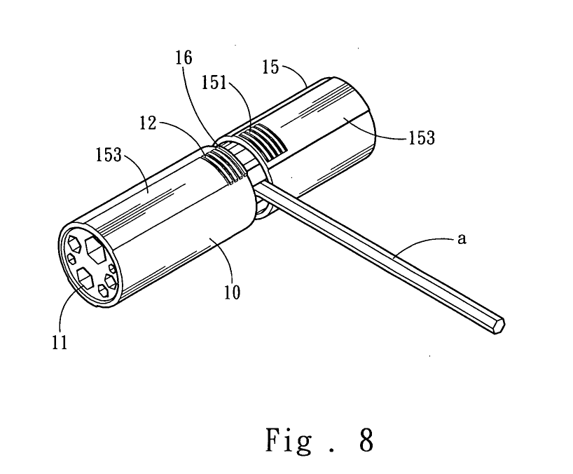

Referring to FIGS. 7 and 8, by means of the construction set forth above, the insertion bores 11 of the handgrip 10 can hold hex wrench (a) of varying sizes and specifications. When in use, fetch a required hex wrench (a) and wedge it in one clipping trough 13, then move the sliding cap 15 to cover the outer side of the hex wrench (a) with one end of the hex wrench (a) exposed to engage with a nut of a work piece (not shown in the drawings), and the handgrip 10 may be turned to fasten or unfasten the nut. Referring to FIG. 3, the latch hook 152 on the sliding cap 15 may be aligned with the guiding trough 14 of the handgrip 10 by mating the first notation 12 of the handgrip 10 and the second notation 151 of the sliding cap 15 to facilitate visual inspection and touch sense.

Users may also place the longer end of the hex wrench (a) into the insertion bore 11 of handgrip 10 to expose the shorter end of the hex wrench (a) to engage with the nut (not shown in the drawings) for fastening or unfastening.

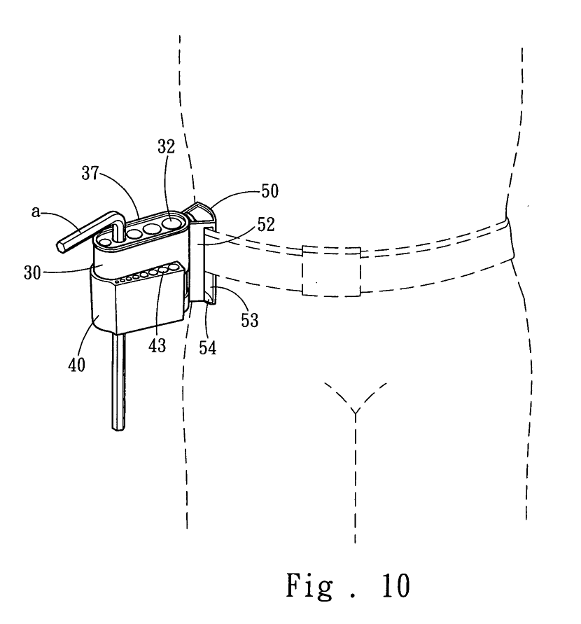

Referring to FIG. 9, the first wrench housing 30 may be coupled with the second wrench housing 40 and the hanging hook 50 for sales. Users can wedge the coupling section 35 of the first wrench housing 30 with the coupling trough 55 of the hanging hook 50, and the hanging hook 50 may be hung on a waist belt through the slots 53 with the clipping blade 54 clipping the lower side of the waist belt to prevent breaking away (referring to FIG. 10). The hex wrench (a) held in the first and the second wrench housings 30 and 40 are positioned vertically to facilitate fetching without hindering user's physical movement. When in use, the second wrench housing 40 may be detached from the first wrench housing 30 so that more room is available for removing the hex wrench (a) from the second wrench housing 40.

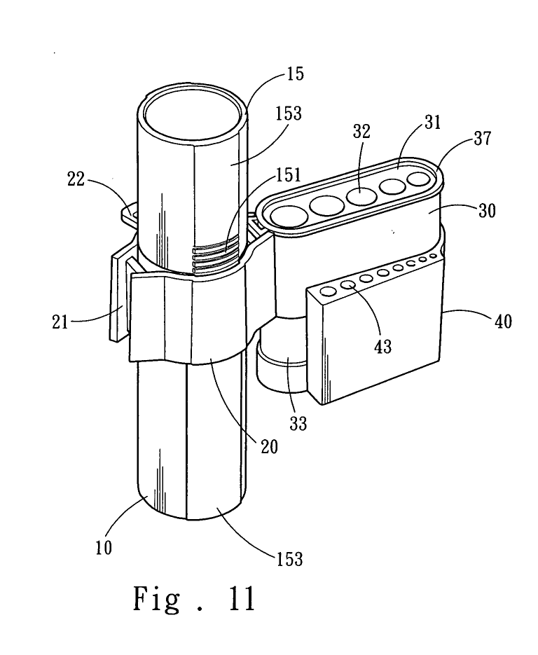

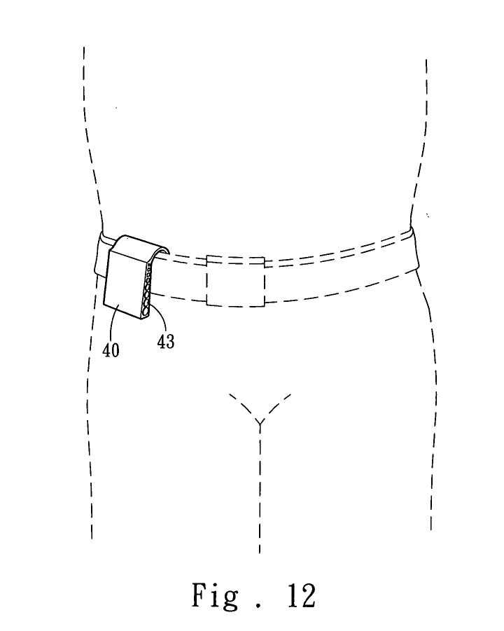

When there is a desire to concurrently use the hex wrenches a of British system or metric system, or a smaller size difference, referring to FIG. 2, the wedge flutes 21 on two sides of the coupling ring 20 may be coupled with two sets of coupling section 35 of the first wrench housing 30, and the retaining section 36 is rested on one end of the coupling ring 20 so that two sets of hex wrenches a of varying sizes and specifications may be held at the same time. Then the outer wall of the first wrench housing 30 may further be coupled with the second wrench housing 40 to hold one set of the hex wrenches a of a smaller size. Referring to FIG. 11, in practice, the coupling ring 20 of the handgrip 10 may be coupled with one set of the first wrench housing 30 through the wedge flute 21 on one side. And the outer wall of the first wrench housing 30 may further be coupled with one set of the second wrench housing 40. Moreover, the U-shaped hook of the second wrench housing 40 may also be coupled on user's waist belt (referring to FIG. 12) to hold one set of the hex wrenches of a smaller size.

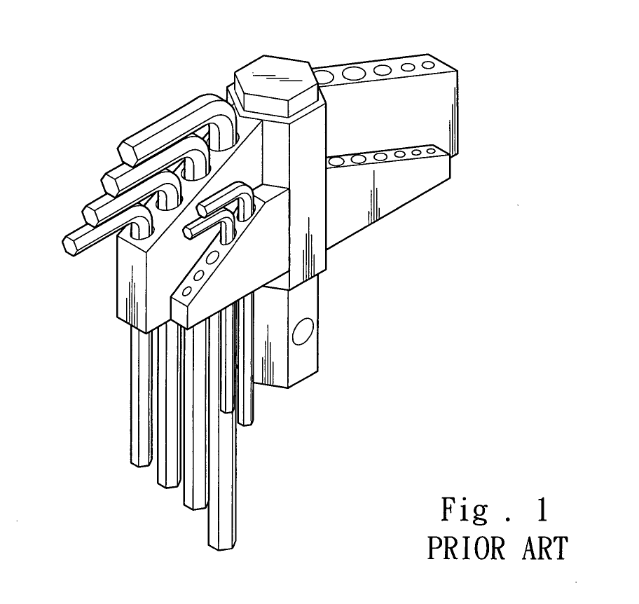

For wrench vendors, the holding member 31 of the first wrench housing 30 that has the insertion bores 32 of varying sizes is a replaceable item to form flexible combinations and configurations. Compared with the tool kit of FIG. 1, the invention can save molding and fabrication costs. The invention also provides an important feature that can be configured and assembled as a Lego toy to form versatile combinations and selections that can be dynamically changed and replaced according to requirements.

What is claimed is:

1. A composite wrench kit, comprising:
a rod-shaped handgrip which has at least one bulged wall on the outer periphery and a brake section formed radially on an inner wall;
a hollow coupling ring for coupling on the handgrip having a trough on an inner wall corresponding to the bulged wall, an indented retaining port on one end of an inner side of the trough, and at least one wedge flute on an outer wall;
a first wrench housing having a plurality of first insertion bores of varying sizes formed on one end surface, a coupling section on an outer wall to wedge in the wedge flute of the coupling ring, and a retaining ring formed on the outer wall; and
a second wrench housing formed substantially an annular hook to couple on the first wrench housing having a coupling member on an inner wall to couple with the retaining ring of first wrench housing, and a plurality of insertion bores of varying sizes formed on an outer end surface of the second wrench housing.

2. A composite wrench kit as claimed in claim 1, wherein the handgrip has two ends of different diameters, a first end having a diameter greater than that of the second end and a plurality of hex insertion bores of varying sizes formed therein, the second end having hex clipping troughs of varying sizes to couple respectively a hex wrench, the second end further being coupled with a hollow sliding cap.

3. A composite wrench kit as claimed in claim 1, wherein the handgrip and the sliding cap have respectively a plurality of stripe notations formed on an outer wall, the handgrip having an axial guiding trough on the second end and an anchor plate on a rear end of the guiding trough, the sliding cap having a latch hook on an inner wall slidable in the guiding trough to be stopped by the anchor plate.

4. A composite wrench kit as claimed in claim 1, wherein the coupling ring has two troughs on the inner wall opposing each other, two wedge flutes on two opposite outer sides and an ear on one end of an inner side, the handgrip having two bulged walls on the outer periphery opposite to each other.

5. A composite wrench kit as claimed in claim 1, wherein the first wrench housing is hollow and substantially annular having one side to receive a holding member, the holding member having a plurality of first insertion bores of varying size formed on an outer side, at least one latch spot on a upper side and a lower side of the outer wall to be confined by an inner wall of the first wrench housing, the coupling section of the first wrenching housing having a retaining section on an outer end to rest on one end surface of the wedge flute of the coupling ring.

6. A composite wrench kit as claimed in claim 1, wherein the retaining ring of the first wrench housing has an indented ditch on each of two opposite sides, the second wrench housing having a latch ridge on the inner wall corresponding to the ditch.

7. A composite wrench kit as claimed in claim 1, wherein the coupling section of the first wrench housing is engageable with a hanging hook, the hanging hook having an outer wall and an inner wall to form a slot therebetween that has an opening directing downwards, the outer wall having a bottom to couple with a clipping blade which is extended inwards to taper the opening, the inner wall having a wedge trough to couple with the coupling section of the first wrench housing.

8. A composite wrench kit, substantially as described and illustrated herein with reference to FIGS. 2, 3, 4, 5, 6, 7, 8, 9, 10, 11 and 12.
